(19) United States
(12) Patent Application Publication
(10) Pub. No.: US 2006/0291687 A1
(43) Pub. Date: Dec. 28, 2006

(54) Vehicle-mounted speaker device and vehicle having the same

(75) Inventor: Koji Maekawa, Tendo-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/473,174

(22) Filed: Jun. 23, 2006

(30) Foreign Application Priority Data
Jun. 23, 2005 (JP) P2005-183570

(51) Int. Cl. H04R 1/02

(52) U.S. Cl. 381/389

(57) ABSTRACT

A vehicle having a vehicle-mounted speaker device attached to a spare tire accommodation unit for use has a vehicle-mounted speaker unit, which is fixedly attached to the accommodation unit and radiates sound, and causes an accommodation lid of the accommodation unit to act as a passive vibrating plate to the sound radiated from the vehicle-mounted speaker unit. Since the accommodation unit is used as a sound space, and the accommodation lid is vibrated as the passive vibrating plate, an output sound pressure level can be increased in any arbitrary frequency band. As a result, a sufficient sound pressure level can be secured, and compensated in a frequency band in which the output sound pressure level is conventionally insufficient.

### BACKGROUND OF THE INVENTION

1. Field of the Invention

The present invention relates to a technical field of a vehicle-mounted speaker device and a vehicle having the same, and more particularly to a technical field of a vehicle-mounted speaker device attached to a spare tire accommodation unit for use and the like.

2. Description of the Related Art

There is conventionally disclosed a vehicle-mounted speaker device attached to a spare tire accommodation unit in a trunk room for use (refer to, for example, EP 0653331 A1).

Further, there is disclosed a vehicle-mounted speaker device used in a vehicle having a rear tray board for partitioning a occupant's compartment from a trunk room for the purpose of increasing heavy low sound (refer to, for example, Japanese Patent No. 3202220).

### SUMMARY OF THE INVENTION

However, the conventional technology disclosed in EP 0653331 A1 intends to effectively utilize the spare tire accommodation unit in the trunk room, and pays no attention to the quality of the sound radiated from the vehicle-mounted speaker device.

Further, the conventional technology disclosed in Japanese Patent No. 3202220 has the purpose of improving sound quality by increasing the heavy low sound, makes a bass reflex speaker system by resonating the reproduced sound from the back surface of the speaker using a sound resonating path, and radiates the heavy low sound from the back surface of the speaker to a vehicle compartment. However, the technology is defective in that a back cavity unit constituting the sound resonating path is complex, and its weight is increased.

A problem to be solved by the present invention is, for example, to provide a vehicle-mounted speaker device for improving the sound quality in a low sound region by a light and simple structure.

In order to solve the above problems, the invention according to claim 1 relates to a vehicle-mounted speaker device attached to a spare tire accommodation unit for use, comprising:

a speaker unit for radiating sound to the spare tire accommodation unit; and

a passive vibrating plate that forms a sound space in the spare tire accommodation unit and is vibrated in response to the sound radiated from the speaker unit to the sound space.

A passive vibrating plate is also referred to as a passive radiator.

In order to solve the above problems, the invention according to claim 4 relates to a vehicle-mounted speaker device attached to a spare tire accommodation unit in a trunk room for use, comprising:

a speaker unit for radiating sound to the spare tire accommodation unit;

a sound introduction pipe for introducing the sound radiated from the speaker unit; and

a passive vibrating plate that forms a sound space using at least one side surface of the trunk room, and is vibrated in response to the sound introduced from the sound introduction pipe.

In order to solve the above problems, the invention according to claim 8 relates to a vehicle comprising a vehicle-mounted speaker device according to claim 1.

### BRIEF DESCRIPTION OF THE DRAWINGS

FIG. 1 is a sectional view showing a vehicle-mounted speaker device SP according to an embodiment of the present invention;

FIGS. 2A and 2B are views showing a structure of a speaker device, wherein FIG. 2A is a view showing a structure of the vehicle-mounted speaker device SP (model 1) according to the embodiment, and FIG. 2B is a view showing a structure of a vehicle-mounted speaker device according to a Kelton type speaker device (model 2) for comparison;

FIGS. 3A and 3B are views showing an equivalent circuit of a speaker device, wherein FIG. 3A is a view showing an equivalent circuit of the model 1, and FIG. 3B is a view showing an equivalent circuit of the model 2;

FIG. 4 is a view showing an equivalent circuit of a closed type speaker used for comparison of simulation;

FIG. 5 is a graph showing a result of simulation of the vehicle-mounted speaker device SP according to the embodiment;

FIG. 6 is a schematic sectional view of a speaker device as a modification of the embodiment of the present invention; and

FIG. 7 shows a modification of the vehicle-mounted speaker device SP according to the embodiment of the present invention.

### DESCRIPTION OF THE PREFERRED EMBODIMENTS

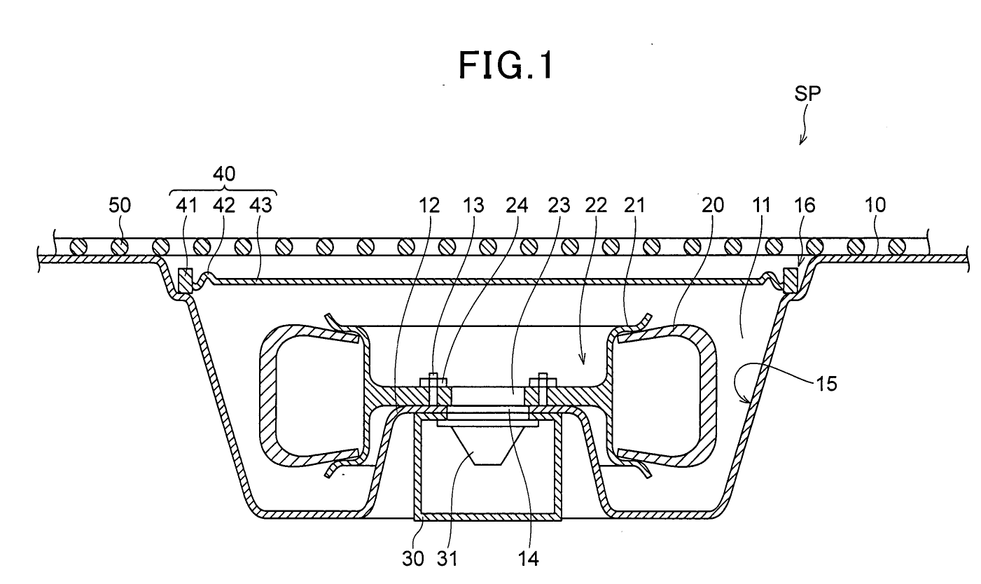

An embodiment of a vehicle-mounted speaker device according to the present invention will be explained using the figures. FIG. 1 is a sectional view showing the vehicle-mounted speaker device SP according to the embodiment of the present invention.

An accommodation unit 11 in which a spare tire 20 is accommodated is disposed on a floor surface 10 of a trunk room. The accommodation unit 11 has a central convex portion 12 at a center, and spare tire fixing volts 13 are welded to the central convex portion 12. A center hub hole 23 is formed at the center of a wheel portion 21 of the spare tire 20, and volt holes (not shown) are formed to a hub mounting portion 22 in the vicinity of the center hub hole 23.

As shown in FIG. 1, a vehicle-mounted speaker unit 31 covered with a speaker box 30 is fixedly attached to the lower side of the central convex portion 12 of the accommodation unit 11.

The central convex portion 12 has a sound radiation hole 14 at a position corresponding to the front side of a vibration surface (not shown) of the vehicle-mounted speaker unit 31 so that the sound radiated from the vibration surface is not shut off.

As shown in FIG. 1, a wall surface 15 of the accommodation unit 11 has a stepped portion 16, and an accommodation lid 40 is attached by being hooked to the stepped portion 16. Then, the accommodation lid 40 forms a space (second sound space to be described later) formed by the accommodation unit 11, and separates the space from the space of the trunk room.

The accommodation lid 40 has a frame 41 along the outside edge of it to support a weight, an edge portion 42 composed of a spring material on the inner periphery side of the outside edge, and further a lid portion 43 on the inner periphery side of the edge portion 42.

The lid portion 43 is formed of, for example, hard board, paper made of pulp, or injection molded foamed resin. The lid portion 43 is fixed to the frame 41 through the edge portion 42.

The edge portion 42 is composed of the spring material such as rubber, elastomer, and the like to return the lid portion 43 to a predetermined position.

A trunk bottom plate 50 having a lattice-like structure is disposed above the accommodation lid 40 so as not to come into contact with the accommodation lid 40. The trunk bottom plate 50 receives the weight of a baggage (not shown) accommodated in the trunk to prevent the weight from being applied to the accommodation lid 40. Further, the lattice-like structure prevents the sound radiated from the vehicle-mounted speaker unit 31 from being shut off.

Here, for example, the vehicle-mounted speaker device SP of the embodiment constitutes a vehicle-mounted speaker device according to the present invention, the accommodation unit 11 constitutes a spare tire accommodation unit according to the present invention, the vehicle-mounted speaker unit 31 constitutes a speaker unit according to the present invention, the accommodation lid 40 constitutes an accommodation lid according to the present invention, the lid portion 43 constitutes a passive vibrating plate according to the present invention, and the trunk bottom plate 50 constitutes a trunk bottom plate according to the present invention, respectively.

In the vehicle-mounted speaker device SP having the arrangement as described above, when a user accommodates the spare tire 20 in the accommodation unit 11, the user removes the trunk bottom plate 50 and the accommodation lid 40, and accommodates the spare tire 20 in the accommodation unit 11. At the time, the spare tire 20 is placed concentrically to prevent the center hub hole 23 of the wheel portion 21 of the spare tire 20 from shutting off the sound radiation hole 14 of the central convex portion 12. The bolt holes (not shown) of the wheel portion 21 are fitted on the fixing volts 13 of the central convex portion 12, and the spare tire 20 is fixed to the central convex portion 12, using fixing nuts 24. Thereafter, the accommodation lid 40 and the trunk bottom plate 50 are attached as they are originally attached. With this operation, the spare tire 20 is fixedly accommodated in the accommodation unit 11.

The spare tire 20 can be taken out in a reverse order of the procedure when it is attached.

Since only a low sound signal is supplied from an amplifier (not shown) to the vehicle-mounted speaker device SP having the above arrangement through a filter (not shown), it is used as a low sound speaker. When the vehicle-mounted speaker device SP generates sound, the vibration surface of the vehicle-mounted speaker unit 31 generates sound in response to the sound signal, and the sound is transmitted to the space (second sound space) of the accommodation unit 11 passing through the sound radiation hole 14 of the central convex portion 12 and the center hub hole 23 of the wheel portion 21. The sound pressure of the transmitted sound impinges on the accommodation lid 40, and vibrates the lid portion 43 of the accommodation lid 40 so that low sound is radiated into the trunk room.

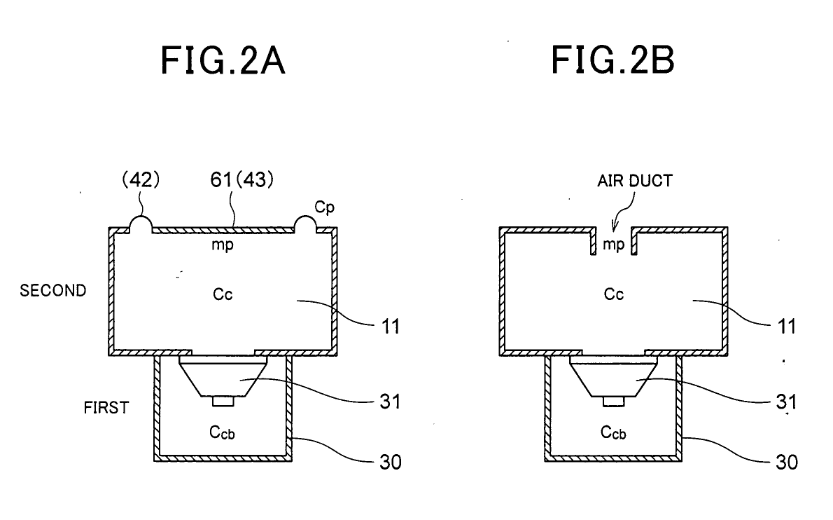

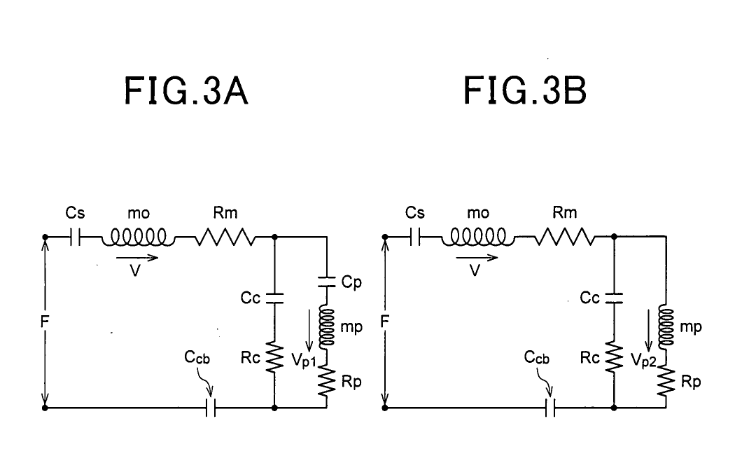

Next, a phenomenon where the vehicle-mounted speaker device SP generates sound will be explained below using figures. FIGS. 2A and 2B are views showing a structure of the speaker device, wherein FIG. 2A is a view showing a structure of the vehicle-mounted speaker device SP (model 1) according to the embodiment, and FIG. 2B is a view showing a structure of a Kelton type speaker device (model 2). FIGS. 3A and 3B views showing an equivalent circuit of a speaker device, wherein FIG. 3A is a view showing an equivalent circuit of the model 1, and FIG. 3B is a view showing an equivalent circuit of the model 2.

As shown in FIG. 2A, the second sound space corresponding to the space of the accommodation unit 11 is formed on the front surface of the speaker box 30, and a passive vibrating plate 61 corresponding to the lid portion 43 of the accommodation lid 40 is disposed on a surface facing the vibrating surface.

Among the sounds radiated by vibrating the vibrating surface of the vehicle-mounted speaker unit 31, the sound radiated from the back surface of the vibrating surface is transmitted to a first sound space formed by the speaker box 30. At the same time, the sound radiated from the front surface of the vibrating surface vibrates the passive vibrating plate 61 corresponding to the lid portion 43 of the accommodation lid 40 through the second sound space corresponding to the space of the accommodation unit 11.

The equivalent circuit of the vehicle-mounted speaker device SP is arranged as shown by FIG. 3A, when the drive force of the vibrating surface of the vehicle-mounted speaker unit 31 is shown by F, the compliance of the suspension of a vibration system of the vehicle-mounted speaker unit 31 is shown by CS, the equivalent mass of the vibration system of the vehicle-mounted speaker unit 31 is shown by mₒ, the mechanical resistance of the vehicle-mounted speaker unit 31 is shown by Rₘ, the compliance of the second sound space is shown by C_{c}, the mechanical resistance of the second sound space is shown by R_{c}, the compliance of the edge portion 42 of the accommodation lid 40 is shown by Cₚ, the equivalent mass of the vibration system of the lid portion 43 of the accommodation lid 40 is shown by mp, the mechanical resistance of the accommodation lid 40 is shown by Rₚ, the compliance of the first sound space is shown by C_{cb}, and the vibration speed of the lid portion 43 of the accommodation lid 40 is shown by Vₚ₁.

The equivalent circuit is shown in a form in which the compliance Cₚ of the edge portion 42 of the accommodation lid 40 is added in series to the equivalent mass of the port of the equivalent circuit of the Kelton type speaker device (model 2) shown in FIG. 3B (accurately, an additive mass resulting from radiation is added to the equivalent mass mₚ of the vibration system of the lid portion of the accommodation lid). Here, Vₚ₂ shows a vibrating speed in an air duct in the model 2.

Since the model 1 has a sound pressure proportional to Vₚ₁, it is the same as the model 2 (Kelton type) having a sound pressure proportional to Vₚ₂. Accordingly, it can be found that the model 1 shows the sound pressure characteristics of a Kelton type band path.

To increase the level of the sound pressure outputted from the lid portion 43 of the accommodation lid 40 in an arbitrary frequency band, the vibration area of the lid portion 43 of the accommodation lid 40 is increased after the second sound space as the space (sound volume) of the accommodation unit 11 is determined. To shift the center frequency, which is a center of a frequency band having a large output sound pressure level, to a low frequency, the equivalent mass mₚ of the lid portion 43 is increased. That is, after the shape of the accommodation unit 11 for accommodating the spare tire 20 has been determined, the center frequency can be manipulated by manipulating the equivalent mass mₚ of the vibration system of the lid portion 43 of the accommodation lid 40.

Likewise, after the second sound space as the space (sound volume) of the accommodation unit 11 has been determined, the center frequency is adjusted by the compliance Cₚ of the suspension of the lid portion 43 of the accommodation lid 40 in the relation to the equivalent mass mₚ of the vibration system of the lid portion 43 of the accommodation lid 40. That is, the center frequency can be also manipulated by changing the material and the shape of the edge portion 42.

Further, the center frequency can be also changed by adjusting the compliance C_{c} of the second sound space. That is, the center frequency can be manipulated by changing the volume of the accommodation unit 11.

Since Q showing the sharpness of resonance is given by an expression Q=ωmₒ/(mechanical resistance), the level of the sound pressure outputted from the lid portion 43 of the accommodation lid 40 is increased, after the center frequency has been manipulated, using the values of two mechanical resistances, that is, the value of the mechanical resistance Rₚ of the accommodation lid 40, and the value of the mechanical resistance R_{c} of the second sound space, after ω (=2πf), that is, a resonance frequency f is determined. Further, the value of the output sound pressure level can be also adjusted in the relation to the resonance frequency (f of ω=2πf) and the equivalent mass mₒ of the vibration system of the speaker unit.

### EXAMPLE

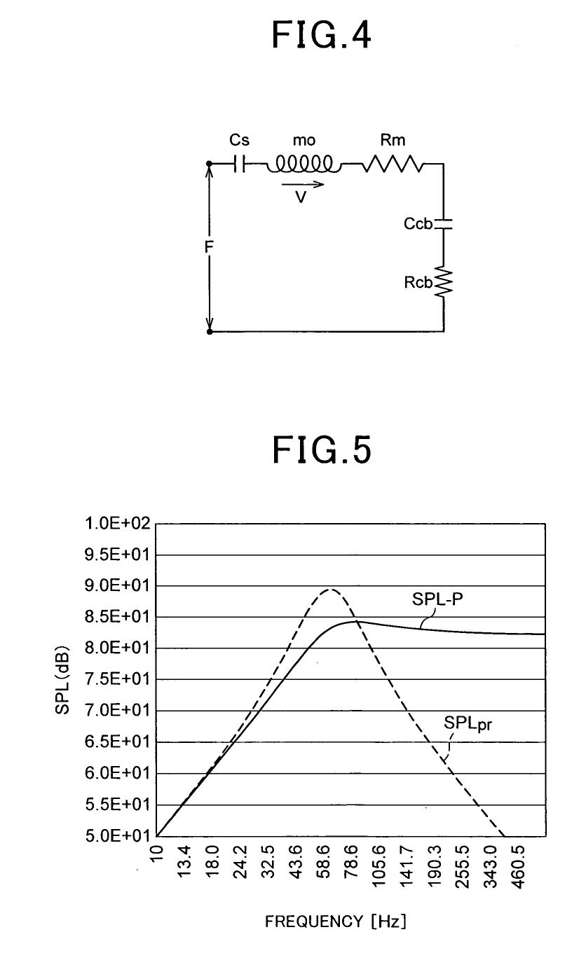

An effect of the present invention will be explained using a result of simulation of the vehicle-mounted speaker SP according to the embodiment. The simulation employs the equivalent circuit of the model 1 shown in FIG. 3A, and the equivalent circuit of a closed type speaker shown in FIG. 4 for comparison. The effect of the present invention will be explained in comparison with the level of the output sound pressure radiated from the closed type speaker.

(Conditions of Simulation)

Simulation was carried out using numerical values that can be applied to an actual product. Specifically, the diameter of the vibration surface of the speaker unit was set to 13 [m], an impedance Ze was set to 4 [Ω], a minimum resonance frequency fₒ was set to 30 [Hz], the equivalent mass mₒ of the vibration system of the speaker unit was set to 13 [g (grams)], and a coefficient of force BL was set to 3.5 [Tm]. The volume of the first sound space corresponding to the speaker box 30 was set to 7 [L (liters)]. The coefficient of force BL is a product of a magnetic flux density B[T (tesla)] in the gap of the magnetic poles of the speaker unit, and the length L[m] of a voice coil in the gap and is an amount for relating an electric system to a mechanical system.

The volume of the second sound space as the space of the accommodation unit 11 (sound volume) was set to 50 [L], the area of the lid portion 43 of the accommodation lid 40 was set to 0.16 [m²] (40 cm×40 cm), the weight was set to 500 [g], and the minimum resonance frequency fₒ was set to 10 [Hz].

(Result of Simulation)

In FIG. 5 showing a result of the simulation, the output characteristics of the equivalent circuit of the model 1 are shown by SPLₚᵣ, and the output characteristics of the closed type speaker for comparison are shown by SPL-P. As shown in FIG. 5, it can be found that the output characteristic SPLₚᵣ of the model 1 can obtain a sound pressure level higher than the output characteristics SPL-P of the closed type speaker in a frequency band equal to or less than 60 Hz in which the closed type speaker SPL-P has a low output sound pressure level.

As a result of the simulation, the above embodiment has the following effect.

The output sound pressure level can be increased in a frequency band in which the closed type speaker has a low output characteristic level, by using the spare tire accommodation unit as the second sound space, and vibrating the lid of the accommodation unit as the passive vibrating plate. Further, it is possible to shift the center frequency of the speaker of the present invention by manipulating a parameter. As a result, a sufficient sound pressure level can be secured in the frequency band in which the output sound pressure level is conventionally insufficient. As a result, it is possible to compensate a main speaker as a sub-woofer.

Since the lid of the spare tire accommodation unit is used as the passive vibrating plate, the spare tire accommodation unit can be effectively utilized, and thus the sound quality in a low sound region can be improved by a simple structure.

Since only the trunk bottom plate having the lattice-like structure is only newly disposed above the lid of the spare tire accommodation unit, the present invention can be realized by a light and simple structure with a slight increase in weight.

To summarize what has been explained above, the vehicle-mounted speaker device SP, which is attached to the spare tire accommodation unit 11 for use, has the vehicle-mounted speaker unit 31 for radiating sound to the accommodation unit 11, and the lid portion 43 that forms the second sound space in the accommodation unit 11, and is vibrated in response to the sound radiated to the second sound space.

A vehicle having the vehicle-mounted speaker device SP, which is attached to the spare tire accommodation unit 11 for use, has the vehicle-mounted speaker unit 31 fixedly attached to the accommodation unit, and radiating sound, and causes the accommodation lid 40 of the accommodation unit 11 to act as the passive vibrating plate to the sound radiated from the vehicle-mounted speaker unit 31.

Since the spare tire accommodation unit 11 is used as the second sound space, and the lid portion 43 is vibrated as the passive vibrating plate, the output sound pressure level can be increased at any arbitrary center frequency. As a result, a sufficient sound pressure level can be secured, and compensated in the frequency band in which the output sound pressure level is conventionally insufficient.

Note that the embodiment of the present invention is not limited to the one described above, and may be modified as, for example, described below.

It is not necessary to separately produce the frame, the edge portion, and the lid portion of the accommodation lid, and they may be formed integrally with each other. In this case, it is possible to provide a spring property by reducing the thickness of the edge portion. Since the number of parts can be reduced, a parts management cost and a manufacturing job cost can be reduced at the time of manufacturing a speaker.

It is also possible to integrate the accommodation lid with the trunk bottom plate. This arrangement can be applied to a vehicle having such a structure that no baggage is placed on the accommodation lid acting as the passive vibrating plate. Although the case in which it is disposed to the trunk room has been explained, the present invention is not limited thereto. For example, the present invention can be applied to a vehicle, in which a spare tire is vertically stored in the vehicle, and the like. In this case, since a component corresponding to the trunk bottom plate having the lattice-like structure can be omitted, the weight can be further reduced.

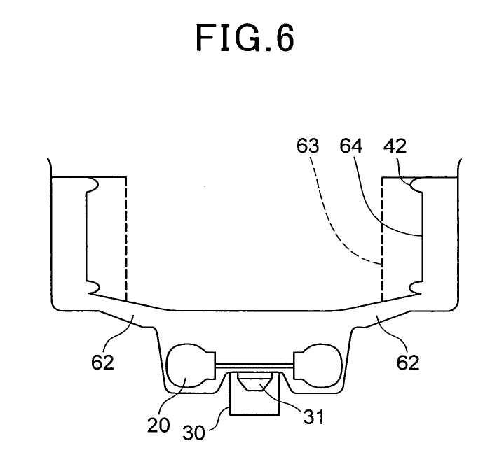

Although the above embodiment explains the case in which the lid of the spare tire accommodation unit on the bottom of the trunk room acts as the passive vibrating plate, the present invention is not limited to this, and can be also applied to, for example, such a structure that the sound space is formed using a side surface of the trunk room as well as has the passive vibrating plate. As shown in FIG. 6, a sound space may be formed on the side surface of the trunk room using a protective cover lattice 63 and a passive vibrating plate 64, the sound radiated from the vehicle-mounted speaker unit 31 attached to the lower side of the accommodation unit 11 of the spare tire 20 may be introduced to the sound space using a sound introduction pipe 62 to vibrate the passive vibrating plate 64.

Here, for example, the sound introduction pipe 62 of the modification constitutes a sound introduction pipe according to the present invention, and the passive vibrating plate 64 constitutes the passive vibrating plate according to the present invention, respectively.

To summarize the modification, the vehicle-mounted speaker device SP, which is attached to the spare tire accommodation unit 11 for use, has the vehicle-mounted speaker unit 31 for radiating sound to the accommodation unit 11, the sound introduction pipe 62 for introducing the sound radiated from the vehicle-mounted speaker unit 31, and the passive vibrating plate 64 that forms the second sound space using at least one side surface of the trunk room, and is vibrated in response to the sound introduced from the sound introduction pipe 62.

A vehicle having the vehicle-mounted speaker device SP, which is attached to the spare tire accommodation unit 11 for use, has the vehicle-mounted speaker unit 31 fixedly attached to the accommodation unit 11 and radiating sound, the sound introduction pipe 62 for introducing the radiated sound, and the passive vibrating plate 64 that forms the second sound space using at least one side surface of the trunk room, and is vibrated in response to the sound introduced from the sound introduction pipe 62.

Since the passive vibrating plate 64 is vibrated using the space formed by the spare tire accommodation unit 11 and the sound introduction pipe 62 as the second sound space, it is possible to increase the output sound pressure level at any arbitrary center frequency. As a result, a sufficient sound pressure level can be secured, and compensated in the frequency band in which the output sound pressure level is conventionally insufficient.

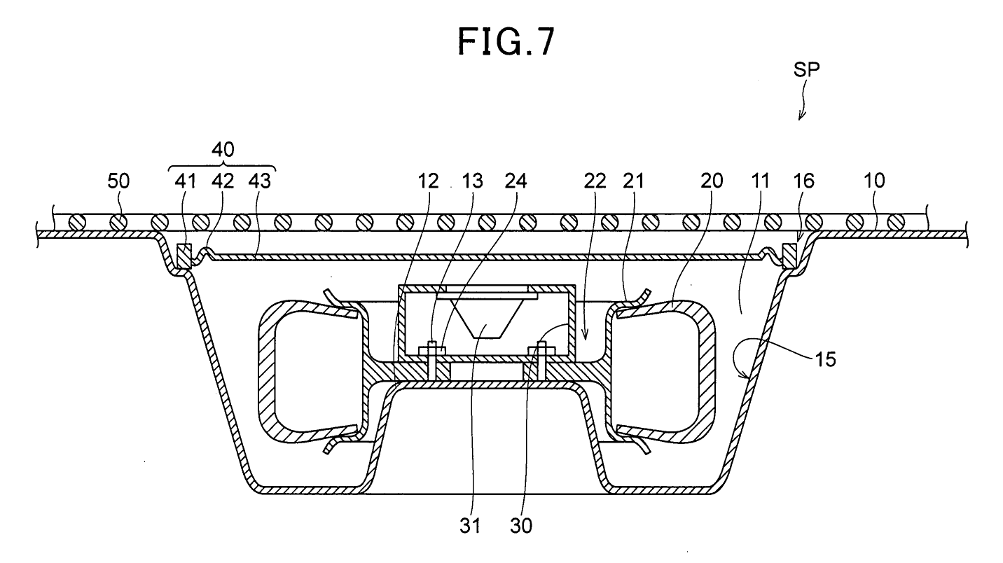

In the vehicle-mounted speaker device SP shown in FIG. 1, although the speaker box 30 is fixedly attached to the lower side of the central convex portion 12, the present invention is not limited to this, and the speaker box 30 may be disposed on the upper side of the central convex portion 12 as shown in FIG. 7. Since the vehicle-mounted speaker unit 31 radiates sound to the second sound space formed by the accommodation unit 11, and the lid portion 43 is vibrated as the passive vibrating plate in response to the radiated sound, the output sound pressure level can be increased at any arbitrary center frequency, similarly with the case of FIG. 1.

Note that, in the example of FIG. 7, the speaker box 30 is tightened together with the spare tire 20.

It should be understood that various alternatives to the embodiment of the invention described herein may be employed in practicing the invention. Thus, it is intended that the following claims define the scope of the invention, and that methods and structures within the scope of these claims and their equivalents be covered thereby.

The entire disclosure of Japanese Patent Application No. 2005-183570 filed on Jun. 23, 2005 including the specification, claims, drawings, and abstract is incorporated herein by reference in its entirety.

What is claimed is:

1. A vehicle-mounted speaker device attached to a spare tire accommodation unit for use, comprising:
a speaker unit for radiating sound to the spare tire accommodation unit; and
a passive vibrating plate that forms a sound space in the spare tire accommodation unit and is vibrated in response to the sound radiated from the speaker unit to the sound space.

2. A vehicle-mounted speaker device according to claim 1, wherein the passive vibrating plate also acts as a lid of the spare tire accommodation unit.

3. A vehicle-mounted speaker device according to claim 1, wherein a trunk bottom plate having a lattice-like structure is disposed above the lid for use.

4. A vehicle-mounted speaker device attached to a spare tire accommodation unit in a trunk room for use, comprising:
a speaker unit for radiating sound to the spare tire accommodation unit;
a sound introduction pipe for introducing the sound radiated from the speaker unit; and
a passive vibrating plate that forms a sound space using at least one side surface of the trunk room, and is vibrated in response to the sound introduced from the sound introduction pipe.

5. A vehicle-mounted speaker device according to claim 1, wherein the peripheral edge of the passive vibrating plate comprises a flexible material.

6. A vehicle-mounted speaker device according to claim 1, wherein the passive vibrating plate entirely comprises a flexible material.

7. A vehicle-mounted speaker device according to claim 1, wherein the output sound pressure level of the passive vibrating plate is increased in a predetermined center frequency.

8. A vehicle comprising a vehicle-mounted speaker device according to claim 1.
